(19) United States
(12) Patent Application Publication
(10) Pub. No.: US 2017/0278038 A1
(43) Pub. Date: Sep. 28, 2017

(54) DISCUSSION RESOURCE RECOMMENDATION

(71) Applicant: Hewlett-Packard Development Company, L.P., Houston, TX (US)

(72) Inventors: Shanchan Wu, Palo Alto, CA (US); Steven J. Simske, Fort Collins, CO (US); Jerry Liu, Palo Alto, CA (US)

(21) Appl. No.: 15/506,200

(22) PCT Filed: Aug. 25, 2014
(86) PCT No.: PCT/US2014/052480

§ 371 Date: Feb. 23, 2017

(51) Int. Cl. G06Q 10/06

(52) U.S. Cl. CPC G06Q 10/06313

(57) ABSTRACT

Systems and methods associated with discussion resource recommendation are disclosed. One example method may be embodied as computer-executable instructions stored on a non-transitory computer-readable medium. The instructions may cause a computer to construct a resource network that links members of asset of online discussion resources. The online discussion resources may be linked based on user participation overlap between members of the set of discussion resources. The instructions may also cause the computer to generate content similarity scores that measure content overlap for pairs of discussion resources. The instructions may also cause the computer to generate network relevancy scores for the pairs of discussion resources based on the resource network. The instructions may also cause the computer to recommend, based on the content similarity scores and the network relevancy scores, a related discussion resource to a user when the user accesses a primary discussion resource.

### BACKGROUND

One way people interact online is via online discussion sites that allow users to discuss various topics via online discussion resources. Online discussion sites include, for example, wikis, online forums, image boards, question and answer websites, and so forth. These sites are made up of numerous discussion resources that may take different forms depending on the type of site. For example, online discussion resources of an online forum are typically referred to as threads, which are characterized by an original post, along with potentially numerous follow up posts by users of the forum. Discussion resources of a wiki may take the form of both wiki pages and of discussion pages associated with wiki pages. Discussion resources of question and answer websites may take the form of a question posted by a first user followed by several answers posted by other uses of the question and answer website that desire to help answer the first users question.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates example data structures on which example systems and methods, and equivalents, may operate.

FIG. 2 illustrates a flowchart of example operations associated with discussion resource recommendation.

FIG. 3 illustrates another flowchart of example operations associated with discussion resource recommendation.

FIG. 4 illustrates an example system associated with discussion resource recommendation.

FIG. 5 illustrates another example system associated with discussion resource recommendation.

FIG. 6 illustrates another flowchart of example operations associated with discussion resource recommendation.

FIG. 7 illustrates another flowchart of example operations associated with discussion resource recommendation.

FIG. 8 illustrates an example computing device in which example systems and methods, and equivalents, may operate.

### DETAILED DESCRIPTION

Systems and methods associated with discussion resource recommendation are described. In various examples, discussion resource recommendation may be achieved by analyzing both the content of the discussion resources, and on user interaction overlap between the discussion resources.

In online websites, there is often content overlap between discussion resources. This may be due to multiple people having similar interests and posting multiple discussion resources related to the interests, discussion resources becoming stale or unused due to a temporary lack of interest, multiple users having similar questions and not searching for an older discussion resource before creating a new discussion resource on the same topic, and so forth. When a user accesses a discussion resource, example systems and methods may attempt to refer the user to related discussion resources in the chance that the information the user is seeking or desires to discuss can be found in one of the related discussion resources. These systems and methods may rely on a variety of factors.

For example, users frequently participate in many discussion resources related to their interests, including discussion resources covering the same topics. By taking into account the activity behavior of users of online discussion resources, discussion resource recommendation logics may identify discussion resources that are more relevant to a user accessing a primary discussion resource, making it easier for the user to find the information sought by the user. Content of the discussion resources may also be taken into account.

More specifically, when a user is viewing a primary discussion resource in an online discussion website, that user may be interested in viewing related discussion resources. This may make it easier for the user to navigate the discussion website, and make it more likely that the user find discussion resources that are relevant to the user.

For example, if a user is seeking a solution to a first problem that is caused by a second problem, the user may be interested in viewing discussion resources related to both the first problem and the second problem. However, if there is limited keyword overlap between the two problems, systems that rely primarily on the content of discussion resources may not be able to identify that there is a relationship between discussion resources that discuss the two problems separately. Thus, the user may be referred to discussion resources dealing with the first problem, when the user may be able to also find useful information in discussion resources regarding the second problem.

In addition to analyzing content, user participation overlap among different discussion resources may be used to detect relationships between different discussion resources. In the above example, users who are interested in the first problem may also be interested in the second problem, and consequently may participate in discussion resources related to both problems. Systems and methods disclosed herein provide for generating a resource network describing the participation overlap of these users. The resource network is then used as a factor when ranking relationships between discussion resources for the purpose of recommending related discussion resources to subsequent users.

When such a subsequent user comes along, because the resource network may indicate that discussion resources regarding the two problems are related, the subsequent user accessing discussion resources regarding the first problem may be referred to discussion resources regarding the second problem. This may provide the subsequent user more useful information regarding the first and second problems than the subsequent user may be referred to if the recommendations were primarily made based on content overlap between discussion resources. Additionally, this subsequent user may be either a member of the online website, or an unregistered user visiting the website for the first time.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring of the description of the examples. Also, the examples may be used in combination with each other. Consequently, the approaches described herein are scalable to essentially any size discussion site content set and/or user base.

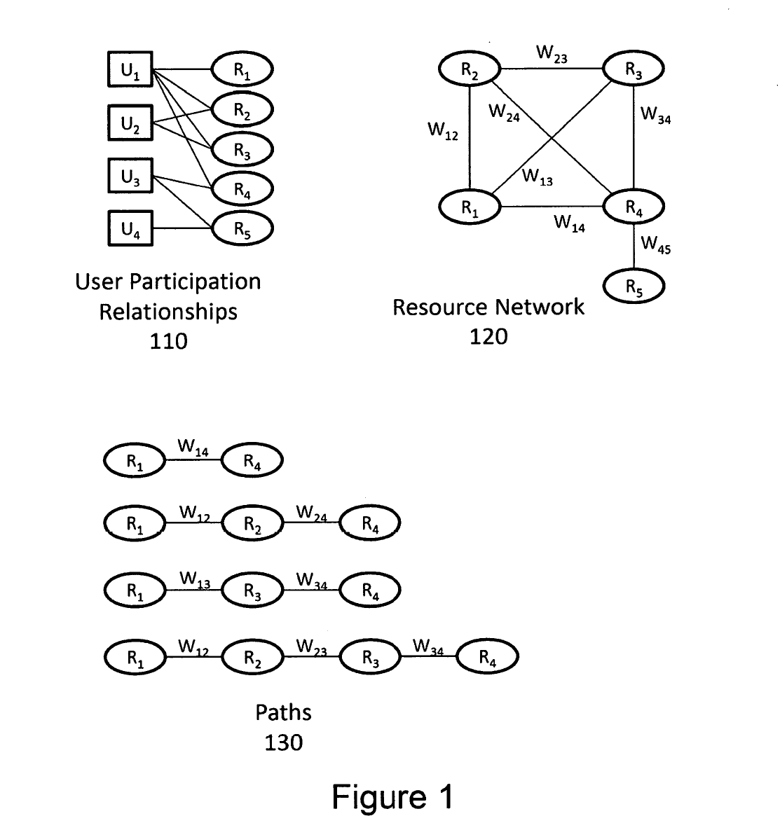

FIG. 1 illustrates example data structures on which example systems and methods, and equivalents may operate. These examples illustrate small data sets to facilitate explanation of the data transformations and analysis being performed. In practice, an online discussion site may have millions of users and/or discussion resources.

FIG. 1 illustrates a set of user participation relationships 110. The user participation relationships are illustrated for an example set of users (U₁-U₄) represented as rectangles and discussion resources (R₁-R₅) represented as ovals. Thus, user participation relationships 110 are the lines connecting the users and resources.

Consequently, in this example, user U₁ has participated in resources R₁, R₂, R₃, and R₄, user U₄ has participated solely in resource R₅, and so forth. In various examples, user participation may include viewing a resource, submitting content to a resource, rating resource, linking to a resource from another location within the discussion website, and so forth, and activities that are treated as participation may depend on the type of discussion resource and/or discussion site format.

By way of illustration, for a question and answer site, it may be appropriate to consider answers posted by users as participation but not questions because users may be likely to respond to questions regarding similar topics but questions submitted by a user may fall outside the user's area of expertise. In another example, activity in a wiki limited to correcting grammar errors left by other users who actually contributed to the content of a wiki article may be treated as non-participatory. This may be detected by, for example, comparing a ratio of text inserted by a user to the amount of punctuation inserted by the user. Grammar and spelling corrections may also be detected by comparing modified text to an original text using, for example Levenshtein distance techniques, Damerau-Levenshtein distance techniques, and so forth.

From user participation relationships 110 a resource network 120 may be generated. Resource network 120 may describe user participation overlap between the resources. For example, user U₁ and user U₂ participate in both resource R₂ and resource R₃, hence there is a link connecting resources R₂ and R₃ in resource network 120. On the other hand, no users participate in both resource R₅ and resource R₁, and consequently there is no direct link between these two resources in resource network 120.

In some example online discussion websites, user participation relationships 110 may not be explicitly annotated in, for example, a database storing information regarding the users and discussion resources. Instead, the database may simply include information regarding user activity in individual discussion resources. Consequently, generating resource network 120 may, for some technologies, include identifying when users participate in multiple discussion resources to identify user participation relationships 110.

In addition to the links indicating user participation overlap in resource network 120, the links may be weighted according to various factors. For example, when many users participate in the same discussion resources, a link between these two discussion resources may be given greater weight within resource network 120 than other links. Consequently resource network 120 may reflect these weights (e.g., weight W₁₂ between resources R₁ and R₂). By way of illustration, both user U₁ and user U₂ participate in both resource R₂ and resource R₃, and user U₁ participates in both resource R₁ and resource R₂. Consequently, weight W₂₃ may be greater than weight W₁₂, indicating that resources R₂ and R₃ are more likely to be related than resources R₁ and R₂.

In another example, links may be given enhanced weight based on the number of resources in which users participate. By way of illustration, user U₁ participates in four resources, while users U₃ and U₂ each participate in two resources. In this example, link weights may be increased by different amounts for users U₁, U₂, and U₃. The amounts may be, for example. 1/(<number of resources participated in by user>). U₄, who participates in a single resource, may not contribute to link weights.

In another example, link weights may be based on how much users participate in individual resources. For example, if user U₁ participates in resources R₁ and R₂ more than user U₁ participates in resource R₃, user U₁ may contribute more to weight W₁₂ than to weight W₁₃ or to weight W₂₃.

When a subsequent user accesses a discussion resource, resource network 120 may be used to identify related discussion resources based on network relevancy. For example, if a user accesses discussion resource R₁, network relevancy may be calculated for other discussion resources in the network. In a naive example, network relevancy may be based solely on link weights to which a resource is connected. In this example, the network relevancy of discussion resource R₄ for a user accessing discussion resource R₁ would be based on the weight W₁₄ of the link between these two discussion resources in resource network 120.

In another example, the network relevancy score may also be based on longer paths 130 through resource network 120. FIG. 1 illustrates four example paths 130 from resource R₁ to resource R₄ through resource network 120 of varying length. In one example, it may be appropriate to give the longer paths less value in calculating network relevancy than shorter paths. Thus, the network relevancy score (Nᵢⱼ) for two nodes i and j may be calculated according to equation 1, where nodes m are nodes in paths in the resource network between nodes i and j, and where s is a decay constant to reduce the weight given in the network relevancy score to paths of longer length.

Nᵢⱼ=Wᵢⱼ+s[Σₘ_{₁}(Wᵢₘ_{₁}*Wₘ_{₁}ⱼ)]+s²[Σₘ_{₁}_{,m2}(Wᵢₘ_{₁}*Wₘ_{₁}ₘ_{₂}*Wₘ_{₂}ⱼ)]+ 1.

Additionally, it may be appropriate to incorporate into the network relevancy score paths 130 through nodes that are along the shortest path involving the node. This may, for example, reduce computation complexity, and prevent loops from being considered when calculating network relevancy scores. Further, it may be appropriate to ignore paths longer than a predefined length when generating network relevancy scores to reduce computation complexity and thereby increase recommendation speed.

In addition to incorporating network score when generating recommendations for related discussion resources, it may also be useful to include information regarding content. Even though many users have overlapping interests, content of discussion resources relating to different interests does not necessarily overlap. Consequently, content similarity scores that describe content overlap between pairs of discussion resources may be created by performing, for example, information retrieval techniques (e.g., BM25), topic model techniques (e.g., Latent Dirichlet Allocation (LDA)), and so forth. Content similarity functions may also work for non-text content including, for example, images, movies, and so forth.

For an information retrieval technique that generates vectors for the content profiles, vectors may be generated based on properties of terms within a content profile (e.g., term frequency, inverse document frequency, document length). These vectors may then be compared against one another to generate content similarity scores. For a topic model, vectors may describe probabilities that a content profile is associated with different topics. As before, the vectors may be compared to generate content similarity scores. A combination of the above techniques, or different techniques, may also be appropriate.

Depending on the type of discussion website, some topics, words, and so forth, may be given improved weight to better steer readers to related discussion resources. For example, in a support website, giving product names an enhanced weight for determining content similarity may make it more likely a user having a problem with a specific product is referred to other discussion resources related to the specific product. For education related discussion resources, critical topics may be given enhanced weight to ensure that users of the discussion resources have easy access to foundational topics. For example, a physics wiki may give enhanced weight to fundamental principles (e.g., the relationship between force, mass and acceleration).

Performing these content analysis techniques may include concatenating content from discussion resources into a single content profile and treating the content profile as a single document. How content is concatenated may depend on the type of discussion website on which systems and/or methods disclosed herein are operating. By way of illustration, concatenating content from an online forum may include concatenating content from a thread including the thread's original post and follow up posts in the thread.

In some circumstances, it may be computationally efficient to limit the length of content profiles on which content analysis is performed by cutting off the content profiles after a certain point. This may be more appropriate for types of discussion resources where content regularly circles back to similar topics if the discussion resource is active for a long period of time. Further, it may be difficult to find information in longer discussion resources, making it beneficial to emphasize content found earlier in discussion resources. In some examples, it may also be appropriate to perform various types of preprocessing on the content profiles (e.g., stop word filtering) to enhance the accuracy of the generation of the content similarity scores.

Once a network relevancy score and content similarity score Cᵢⱼ have been generated for a pair of discussion resources i and j, these scores may be combined into a global relevancy score Gᵢⱼ. In one example, the global relevancy score may be generated according to equation 2 below, where θ₁ and θ₂ are predetermined scaling constants.

Gᵢⱼ=θ₁Nᵢⱼ+θ₂Cᵢⱼ 2.

In equation 2, θ₁ and θ₂ may be non-negative parameters such that θ₁+θ₂=1. The parameters may be determined by, for example, empirical studies, or trained from training data with human supervision. In one example, θ₁ and θ₂ may be updated over time as more data is generated.

Calculating network relevancy scores and content similarity scores may be computationally complex operations. For discussion websites with a large number of discussion resources, it may be efficient to limit the number of pairs of resources for which network relevancy scores and content similarity scores are generated at any given time. Consequently, a comparatively faster operation may be performed to identify discussion resources that are likely to have high content similarity scores and/or network relevancy scores to a primary discussion resource accessed by a user. In one example, keywords may be identified from the primary discussion resource, and a search query may be generated based on the keywords and run over other discussion resources to rank discussion resources that are likely to have high similarity scores. From the rankings, a predetermined number may be selected for which content similarity scores are fully generated.

Once content similarity scores, network relevance scores, and, if appropriate, global relevancy scores have been generated, discussion resources may be ranked according to their respective scores. The user accessing the primary discussion resource may then be presented with references (e.g., hyperlinks) to several of the highest scoring related discussion resources. These may be presented, for example, in a sidebar or side window displayed next to an area displaying the primary discussion resource.

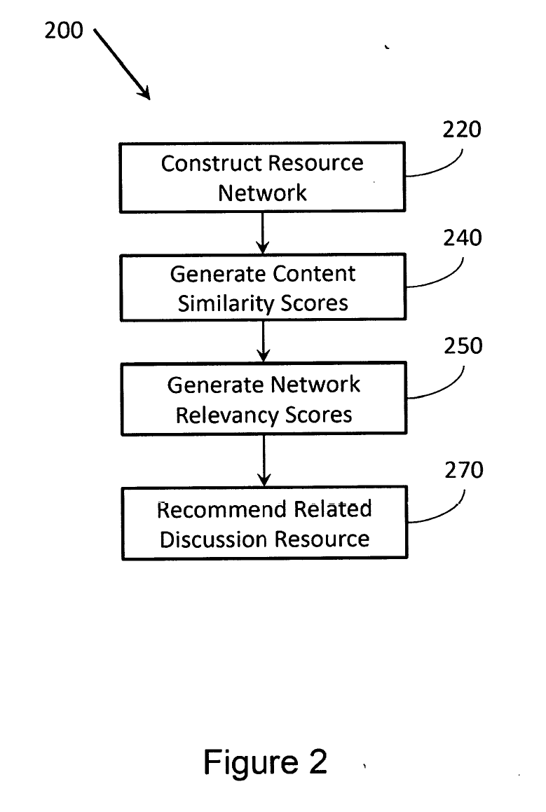

FIG. 2 illustrates a method 200 associated with discussion resource recommendation. It should be appreciated that though actions associated with method 200 are shown in one example ordering in FIG. 2, many actions may occur in different orderings or substantially in parallel with one another. Figures associated with other methods throughout the application may also operate in orderings other than those explicitly illustrated.

Method 200 includes constructing a resource network at 220. The resource network may link members of a set of discussion resources. Thus, the resource network may effectively be a graph where nodes represent discussion resources and edges represent links between the discussion resources. The links may be generated based on user participation overlap between members of the set of discussion resources. Thus, a link may be created between two discussion resources in the resource network when a user is identified as a participant in both of the two discussion resources. If a user participates in more than two discussion resources, links may be created between each pair of discussion resources in which the user participates. Additionally, the links may be weighted based on user participation in the members of the set of discussion resources. Thus, the weights may be based on the number of discussion resources a user participates in, the quantity of participation of the user in discussion resources, the quality of participation of the user in discussion resources, and so forth.

Method 200 also includes generating content similarity scores for pairs of discussion resources at 240. Content similarity scores may measure content overlap for pairs of discussion resources. Content similarity scores may be generated using, for example, the cosine model, BM25, LDA, an information retrieval model, a topic model, and so forth. These models and algorithms may generate vectors describing the content of the various discussion resources, which may be multiplied against one another to generate a score indicating how related pairs of discussion resources are (e.g., a higher score indicates more content overlap).

Method 200 also includes generating network relevancy scores for pairs of discussion resources at 250. The network relevancy scores may be generated based on the resource network constructed at action 220. A network relevancy score for an evaluated pair of discussion resources may be generated as a function of a link weight of a link between the evaluated pair of discussion resources. Thus, a pair of discussion resources having a higher link weight may be treated as more likely to be related. Additionally, the network relevancy score for the evaluated pair of discussion resources may be generated as a function of link weights of links in paths between the evaluated pair of discussion resources. Various techniques for limiting computation quantity described above may be applied to enhance computation efficiency.

Method 200 also includes recommending a related discussion resource at 270. The related discussion resource may be recommended to a user when the user accesses a primary discussion resource. By way of illustration, if a user of an online forum accesses a thread in the forum, the user may be presented a sidebar containing hypertext links to related threads within the forum. The related discussion resource may be recommended based on the content similarity scores and the network relevancy scores.

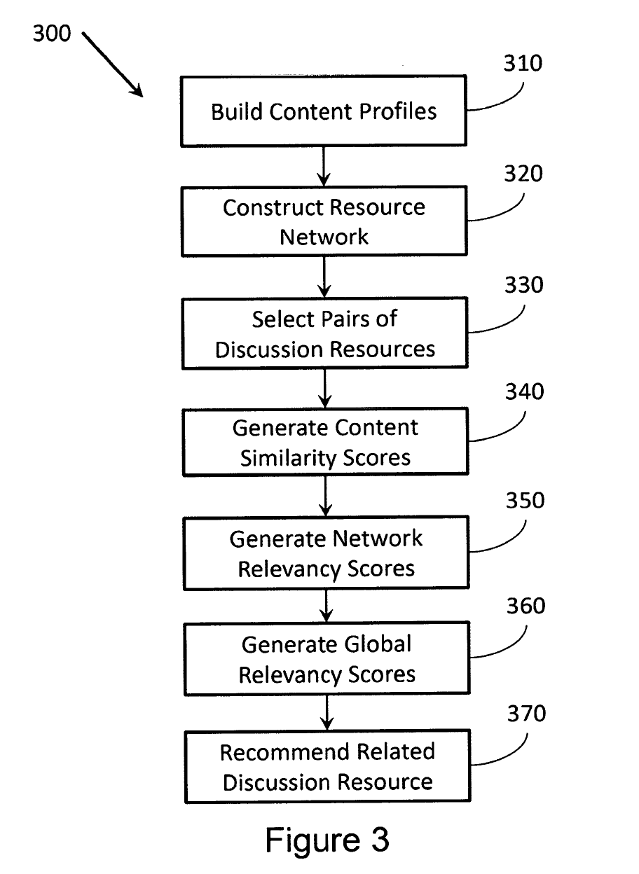

FIG. 3 illustrates a method 300 associated with discussion resource recommendation. Method 300 includes several actions similar to those described above with reference to method 200 (FIG. 2). For example, method 300 includes constructing a resource network at 320, generating content similarity scores at 340, generating network relevancy scores at 350, and recommending a related discussion resource at 370.

Method 300 also includes building content profiles for the discussion resources at 310. In one example, the content profiles may identify topics with which their respective discussion resources are related. In another example, the content profiles may comprise concatenated portions of discussion resources. In some examples, building the content profiles may include performing some preprocessing techniques (e.g., stop word filtering), after which keywords, topics, and so forth may be extracted from content of discussion resources from which respective content profiles are generated.

Method 300 also includes selecting the pairs of discussion resources at 330 for which content similarity scores will be generated at action 340 and for which network relevancy scores will be generated at action 350. The pairs of discussion resources may be selected at action 330 based on, for example, the content profiles of the discussion resources, the primary discussion resource accessed by the user, and so forth. Pre-selecting the pairs of discussion resources may reduce the amount of content similarity scores and network similarity scores that are ultimately calculated, thereby reducing computation quantity for generating a recommendation and potentially increasing the speed at which the related discussion resource is recommended at action 370.

Method 300 also includes generating global relevancy scores for the pairs of discussion resources at 360. The global relevancy scores may be generated based on the respective content relevancy scores and network relevancy scores of the pairs of discussion resources. Consequently, at action 370, the related discussion resource may be recommended based on the global relevancy score.

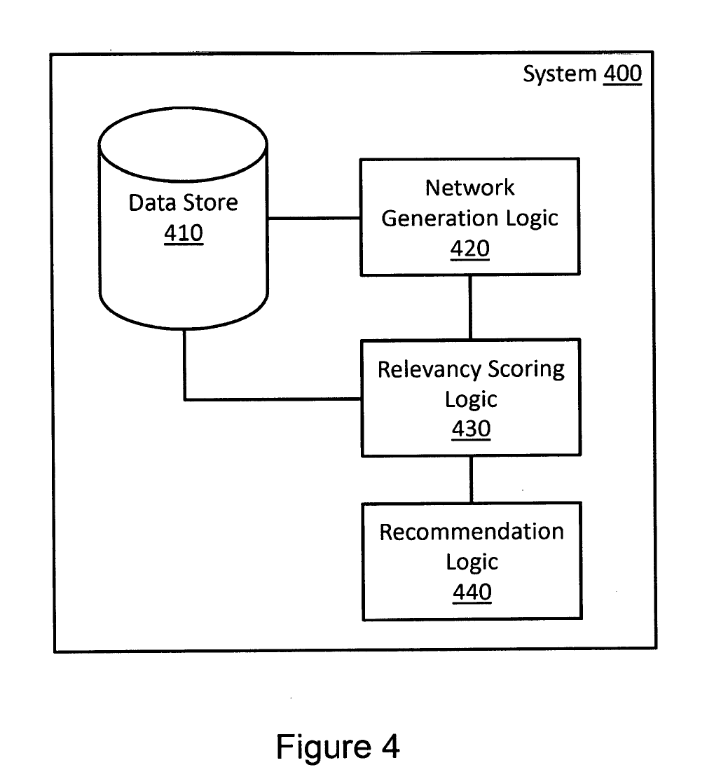

FIG. 4 illustrates an example system 400 associated with discussion resource recommendation. System 400 includes a data store 410. Data store 410 may store discussion resources. A discussion resource comprises content submitted by users. The discussion resources may be part of an online discussion website such as a wiki, an online forum, an image board, a question and answer website, and so forth. Thus, the data store may be a database storing content and other information associated with the online discussion website (e.g., user information).

System 400 also includes a network generation logic 420. Network generation logic 420 may generate a resource network that links a first discussion resource and a second discussion resource. Network generation logic 420 may link the first discussion resource and the second discussion resource when a user has submitted content to both of these discussion resources. Network generation logic 420 may be configured to update the resource network over time, re-generate the resource network periodically, and so forth. In one example, network generation logic 430 may give the link between the first discussion resource and the second discussion resource a weight based on how many discussion resources the user has submitted content to.

System 400 also includes a relevancy scoring logic 430. Relevancy scoring logic 430 may generate relevancy scores for a pair of discussion resources. The relevancy scores may be generated based on links in the resource network that connect paths between the pair of discussion resources. The relevancy scores may also be generated based on content similarity between the pair of discussion resources.

System 400 also includes a recommendation logic 440. Recommendation logic 440 may identify a related discussion resource to a user. The related discussion resource may be recommended based on the relevancy scores generated by relevancy scoring logic 430. The related discussion resource may be recommended in response to the user accessing a primary discussion resource. Consequently, recommendation logic 440 may control relevancy scoring logic 430 to generate the relevancy scores. This may cause relevancy scoring logic 430 to access the resource network generated by network generation logic 420 and content from data store 410.

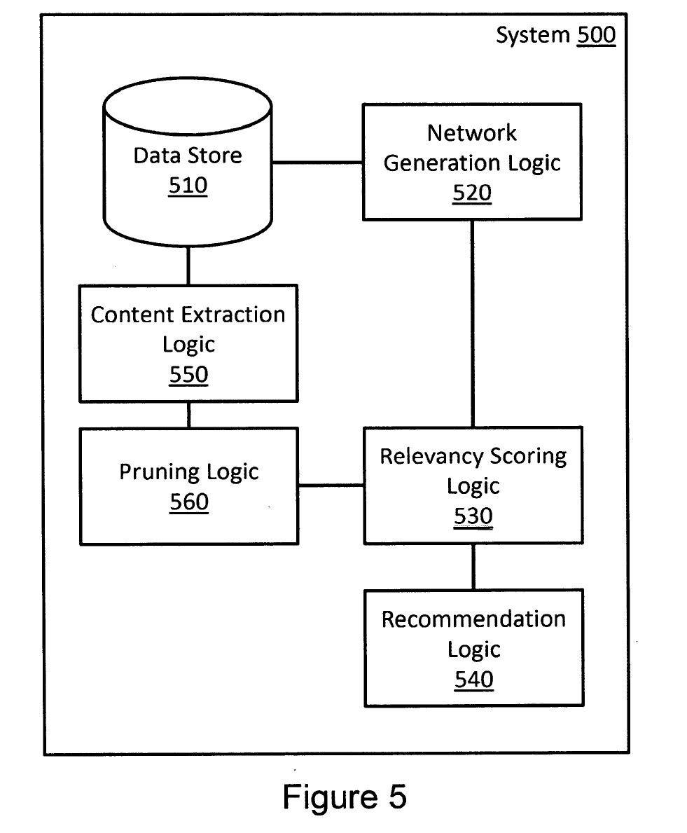

FIG. 5 illustrates a system 500 associated with discussion resource recommendation. System 500 includes several items similar to those described above with reference to system 400 (FIG. 4). For example, system 500 includes a data store 510, a network generation logic 520, a relevancy scoring logic 530, and a recommendation logic 540.

System 500 also includes a content extraction logic 550. Content extraction logic 550 may build content profiles for discussion resources. The content profiles may identify topics with which their respective discussion resources are related. To identify the topics, content extraction logic may perform several actions on discussion resources from data store 510 to generate the content profiles. These actions may include, for example, concatenating content from the discussion resources, performing stop word filtering to remove unimportant words from discussion resources, extracting keywords and/or topics from the discussion resources, and so forth. In one example, relevancy scoring logic 530 may evaluate content similarity based on the content profiles.

System 500 also includes a pruning logic 560. Pruning logic 560 may select pairs of discussion resources for scoring by the relevancy scoring logic based on the content profiles. Pruning logic 560 may select the pairs to limit the number of pairs for which scoring is performed by relevancy scoring logic 530. This may speed up the response time of recommendation logic 540 by reducing the amount of computation performed when a user is being provided related resources.

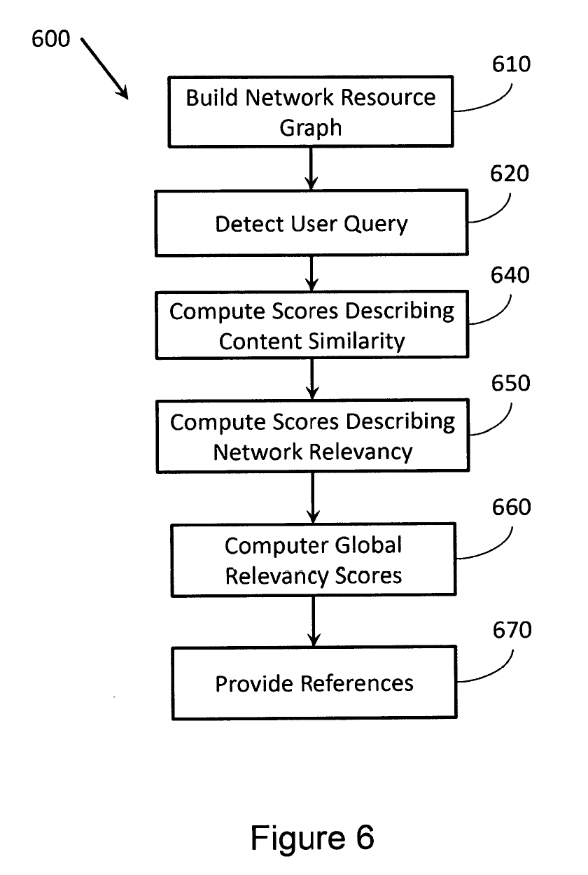

FIG. 6 illustrates a method 600 associated with discussion resource recommendation. Method 600 includes building a resource network graph at 610. Nodes in the graph may represent discussion resources. Edges in the graph may be generated based on user participation overlap between the discussion resources. Edges in the graph may be weighted based on how many discussion resources users participate in.

Method 600 also includes detecting a user query at 620. The user query may identify a primary discussion resource. In an alternative example, the user query may be implicitly generated based on, for example, keywords that brought the user to the primary discussion resource. In response to the user query, several actions may be performed as a part of method 600.

Method 600 also includes computing scores describing content similarity between members of a set of the discussion resources and the primary discussion resource at 640. The scores describing content similarity may be computed as a function of keyword overlap between the respective members of the set of discussion resources and the primary discussion resources. Keyword overlap may refer to a relative sharing of keywords and/or key phrases between discussion resources. The scores describing content similarity may be generated as a function of keyword overlap between the members of the set of the discussion resources and the primary discussion resource.

Method 600 also includes computing scores describing network relevancy between the members of the set of the discussion resources and the primary discussion resource at 650. The scores describing network relevancy may be generated as a function of edge weights of edges in the graph connecting the members of the set of discussion resources and the primary discussion resource.

Method 600 also includes computing global relevancy scores for the members of the set of discussion resources at 660. The global relevancy scores may be computed based on respective scores describing network relevancy and respective scores describing content similarity. In one example, the global relevancy scores may be calculated based on a linear model. The linear model may be generated based on, for example, empirical studies, training data, and so forth.

Method 600 also includes providing references to a set of related discussion resources at 670. The related discussion resources may be selected from the members of the set of discussion resources. The related discussion resources may be selected based on the global relevancy scores. The references may be provided to the user as a result of the user selecting the primary discussion resource.

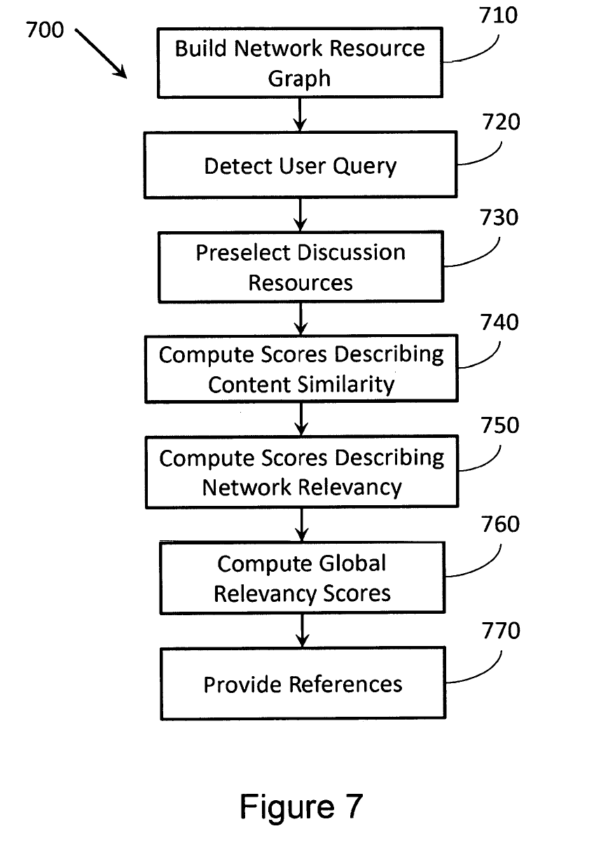

FIG. 7 illustrates a method 700 associated with discussion resource recommendation. Method 700 includes several actions similar to those described above with reference to method 600 (FIG. 6). For example, method 700 includes building a network resource graph at 710, detecting a user query identifying a primary discussion resource at 720, computing scores describing content similarity between members of a set of discussion resources and the primary discussion resource at 740, computing scores describing network relevancy at 750, computing global relevancy scores at 760, and providing references at 770.

Method 700 also includes preselecting the members of the set of discussion resources for which scores describing content similarity and scores describing network relevancy are generated at 730. The members of the set of discussion resources may be selected from the discussion resources represented in the graph. The members of the set of discussion resources may be selected based on a likelihood of content overlap between the respective members of the set of discussion resources and the primary discussion resource. The quantity of members of the set of discussion resources preselected may be determined based on a desired balance of recommendation quality and computation efficiency.

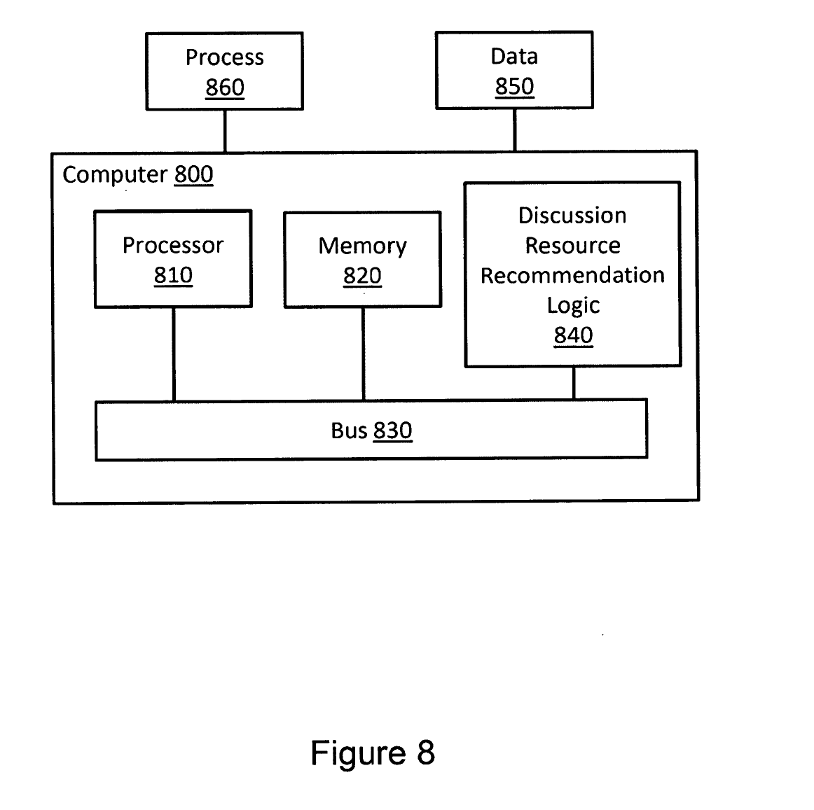

FIG. 8 illustrates an example computing device in which example systems and methods, and equivalents, may operate. The example computing device may be a computer 800 that includes a processor 810 and a memory 820 connected by a bus 830. The computer 800 includes a discussion resource recommendation logic 840. In different examples, discussion resource recommendation logic 840 may be implemented as a non-transitory computer-readable medium storing computer-executable instructions in hardware, software, firmware, an application specific integrated circuit, and/or combinations thereof. Consequently, discussion resource recommendation logic 840 may embody at least a portion of one of the methods (e.g., method 200) or systems (e.g., system 400) described above.

The instructions may also be presented to computer 800 as data 850 and/or process 860 that are temporarily stored in memory 820 and then executed by processor 810. The processor 810 may be a variety of various processors including dual microprocessor and other multi-processor architectures. Memory 820 may include volatile memory (e.g., read only memory) and/or non-volatile memory (e.g., random access memory). Memory 820 may also be, for example, a magnetic disk drive, a solid state disk drive, a floppy disk drive, a tape drive, a flash memory card, an optical disk, and so on. Thus, Memory 820 may store process 860 and/or data 850. Computer 800 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A non-transitory computer-readable medium storing computer-executable instructions that when executed by a computer cause the computer to:
construct a resource network that links members of a set of discussion resources based on user participation overlap between members of the set of discussion resources;
generate content similarity scores for pairs of discussion resources, where a content similarity score measures content overlap for a pair of discussion resources,
generate network relevancy scores for the pairs of discussion resources based on the resource network; and
recommend, based on the content similarity scores and the network relevancy scores, a related discussion resource to a user when the user accesses a primary discussion resource.

2. The non-transitory computer-readable medium of claim 1, where links are weighted based on user participation in the members of the set of discussion resources.

3. The non-transitory computer-readable medium of claim 1, where a network relevancy score for an evaluated pair of discussion resources is generated as a function of a link weight of a link between the evaluated pair of discussion resources and as a function of link weights of links in paths between the evaluated pair of discussion resources.

4. The non-transitory computer-readable medium of claim 1, where the instructions further cause the computer to:
build content profiles for the discussion resources, where the content profiles identify topics with which their respective discussion resources are related; and
select pairs of discussion resources.

5. The non-transitory computer-readable medium of claim 4, where the pairs of discussion resources are selected based on one or more of: the content profiles of the discussion resources, and the primary discussion resource.

6. The non-transitory computer-readable medium of claim 4, where the content profiles are generated based on portions of content from the discussion resources.

7. The non-transitory computer-readable medium of claim 1, where the instructions further cause the computer to:
generate global relevancy scores for the pairs of discussion resources based on their respective content relevancy scores and network relevancy scores, and where the related discussion resource is recommended to the user based on the global relevancy scores.

8. A system, comprising:
a data store to store discussion resources, where a discussion resource comprises content submitted by users:
a network generation logic to generate a resource network that links a first discussion resource and a second discussion resource when a user has submitted content to first discussion resource and to the second discussion resource;
a relevancy scoring logic to generate relevancy scores for a pair of discussion resources based on links in the resource network that connect paths between the pair of discussion resources and based on content similarity between the pair of discussion resources; and
a recommendation logic to identify to a requesting user, based on the relevancy scores, a related discussion resource in response to the user accessing a primary discussion resource.

9. The system of claim 8, comprising:
a content extraction logic to build content profiles for discussion resources, where the content profiles identify topics with which their respective discussion resources are related, and
where the relevancy scoring logic evaluates content similarity based on the content profiles.

10. The system of claim 9, comprising a pruning logic to select pairs of discussion resources for scoring by the relevancy scoring logic based on the content profiles.

11. The system of claim 8, where the network generation logic gives the link between the first discussion resource and the second discussion resource a weight based on how many discussion resources the user has submitted content to.

12. A method, comprising:
building a resource network graph, where nodes in the graph represent discussion resources, where edges in the graph are generated based on user participation overlap between the discussion resources, and where edges in the graph are weighted based on how many discussion resources users participate in; and
in response to a user query identifying a primary discussion resource:
computing scores describing content similarity between members of set of the discussion resources and the primary discussion resource as a function of keyword overlap between the members of the set of the discussion resources and the primary discussion resource;
computing scores describing network relevancy between the members of the set of the discussion resources and the primary discussion resource as a function of edge weights of edges in the graph connecting the members of the set of discussion resources and the primary discussion resource;
computing, for the members of the set of discussion resources, global relevancy scores based on respective scores describing network relevancy and respective scores describing content similarity; and
providing, to the user, references to a set of related discussion resources from the members of the set of discussion resources based on the global relevancy scores.

13. The method of claim 12, comprising preselecting, from the discussion resources, the members of the set of the discussion resources for which scores describing content similarity and scores describing network relevancy are generated based on a likelihood of content overlap between the respective members of the set of discussion resources and the primary discussion resource.

14. The method of claim 13, where a quantity of members of the set of discussion resources preselected is determined based on a desired balance of recommendation quality and computation efficiency.

15. The method of claim 12, where the global relevancy scores are calculated based on a linear model, and where the linear model is generated based on one or more of, empirical studies and training data.
